(19) United States
(12) Patent Application Publication
(10) Pub. No.: US 2023/0386367 A1
(43) Pub. Date: Nov. 30, 2023

(54) SURGICAL REPAIR SIMULATION DEVICES

(71) Applicant: The Children's Medical Center Corporation, Boston, MA (US)

(72) Inventors: Michael G. Silver, Ashland, MA (US); Lindsey Minahan, Waltham, MA (US); Gregory Loan, Boston, MA (US); Stephen F. Wilson, North Easton, MA (US); Carolyn R. Rogers-Vizena, Westwood, MA (US); Jill M. Zalieckas, Lincoln, MA (US); Belinda Dickie, Weston, MA (US)

(73) Assignee: The Children's Medical Center Corporation, Boston, MA (US)

(21) Appl. No.: 18/320,927

(22) Filed: May 19, 2023

Related U.S. Application Data
(60) Provisional application No. 63/347,418, filed on May 31, 2022.

(51) Int. Cl. G09B 23/30

(52) U.S. Cl. CPC G09B 23/30

(57) ABSTRACT

Surgical simulation devices including surgical models of various anatomical malformations as well as their methods of use and manufacture are described. In some embodiments, a surgical simulation device includes a base, a surgical model that simulates an anorectal malformation, and a model support. The model support is an internal volume sized and shaped to receive at least a portion of the surgical model such that an operating surface of the surgical model is exposed. The model support is releasably engaged with the base. In other embodiments, surgical models with simulated tissues including tissue reinforcement are described.

### RELATED APPLICATIONS

This application claims the benefit of priority under 35 U.S.C. 119(e) of U.S. Provisional Application Ser. No. 63/347,418, filed May 31, 2022, the disclosure of which is incorporated herein by reference in its entirety.

### FIELD

Disclosed embodiments are related to surgical repair simulation devices and related methods of use.

### BACKGROUND

In addition to other surgical procedures, malformation repairs may be critical surgical procedures that may result in a severely problematic immediate and/or chronic patient outcome if the procedure is not performed optimally. For example, various anorectal malformation (ARM) conditions may involve improper development of the rectum in relation to other internal pelvic organs. Other types of malformation repair may include cleft lip repair procedures in addition to other procedures a subject may undergo.

### SUMMARY

In some embodiments, a surgical simulation device may comprise a base, a surgical model, and a model support. The surgical model may be configured to simulate an anorectal malformation. The model support may include an internal volume sized and shaped to receive at least a portion of the surgical model such that an operating surface of the surgical model may be exposed. The model support may further be configured to be releasably engaged with the base.

In other embodiments, a method of surgical simulation may comprise inserting a first surgical model of a surgical simulation device into a base of the surgical simulation device and performing a first simulated surgical procedure on the first surgical model. The method may further comprise removing the first surgical model from the base, inserting a second surgical model into the base of the surgical simulation device, and performing a second simulated surgical procedure on the second surgical model. In some embodiments, at least one of the first and second simulated surgical models may be configured to simulate an anorectal malformation.

In further embodiments, a surgical model may comprise at least one simulated muscle including a reinforcing material disposed therein, and a second simulated tissue at least partially encapsulating the at least one simulated muscle.

In still further embodiments, a surgical model may comprise a simulated organ including at least one lumen, and at least one flexible reinforcing material. The at least one flexible reinforcing material may extend at least partially around and at least partially along a length of the at least one lumen. In some embodiments, the at least one flexible reinforcing material may be embedded in a flexible matrix of the simulated organ

In some embodiments, a surgical model may comprise a simulated tissue and an opening formed in the simulated tissue. A plurality of reinforcing materials may extend at least partially in a first direction, and a first portion of the plurality of reinforcing materials may extend around a first side of the opening. A second portion of the plurality of reinforcing materials may extend around a second side of the opening.

In yet further embodiments, a surgical model may comprise an elongated simulated tissue and a plurality of reinforcing materials which may extend along a length of at least a portion of the elongated simulated tissue. The plurality of reinforcing materials may extend in a direction that is substantially parallel to a length of the portion of the elongated simulated tissue.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective top view of an anorectal malformation (ARM) repair simulation device according to one embodiment;

FIG. 2 is a side view of an ARM repair simulation device according to one embodiment;

FIG. 3 is a perspective top view of a base of an ARM repair simulation device according to one embodiment;

FIG. 4 is a perspective top view of a surgical model of an ARM repair simulation device according to one embodiment;

FIG. 5A is a perspective top view of a model support of an ARM repair simulation device according to one embodiment;

FIG. 5B is a perspective top view of a surgical model with the model support removed according to one embodiment;

FIG. 6 is a front view of an ARM repair simulation device according to one embodiment, with a simulated skin layer and a simulated fat layer removed to show internal features according to one embodiment;

FIG. 7 is a perspective side view of a first and second simulated muscle of an ARM repair simulation device according to one embodiment;

FIG. 8 is a cross-sectional side view of an ARM repair simulation device according to one embodiment;

FIG. 9 is a cross-sectional side view of an ARM repair simulation device according to another embodiment;

FIG. 10 is a close-up cross-sectional front view of an ARM repair simulation device according to one embodiment;

FIG. 11 is a cross-sectional view of an ARM repair simulation device according to one embodiment;

FIG. 12 is a flow chart depicting a surgical simulation method according to one embodiment;

FIG. 13 is a perspective view of a cleft lip repair simulation device according to one embodiment;

FIG. 14 is a cross-sectional view of the cleft lip repair simulation device of FIG. 13; and

FIGS. 15A-15F are schematic cross sectional views of a molding process for a surgical model.

### DETAILED DESCRIPTION

As noted above, various conditions such as anorectal malformation (ARM) and cleft lip may require surgical repair. Depending on the nature of the condition and the repair procedure, outcomes from a repair procedure may be critical to patient health and/or appearance. Accordingly, it may be desirable for a surgeon performing a repair procedure to have undergone significant training related to the specific procedure being performed. However, training for some repair procedures may be difficult to obtain because of the relative infrequency of ARM conditions and cleft lip. Additionally, live training on a clinical patient may be associated with increased risk to the patient's health and/or appearance depending upon the specific repair procedure to be practiced.

In view of the above, the inventors have recognized and appreciated the benefits associated with an ARM repair simulation device that may provide a physical model on which an ARM repair procedure may be simulated. Such a device may allow the steps of an ARM repair procedure to be performed, repeated, or practiced on a surgical model without the need for a real patient. This may allow a surgeon to improve the specific skills needed for ARM repair and facilitate improvement of patient outcomes.

In some embodiments, an ARM surgical model may be configured to be releasably engaged with a base of the device, such that the surgical model may be inserted and removed while the base may be re-used with another surgical model. This modular functionality may reduce costs associated with both the manufacture and use of the device. Furthermore, the modularity may allow a single base to be used with various surgical models simulating different ARM conditions, permitting a surgeon to practice a range of ARM repair procedures using a single device. As elaborated on further below, unlike earlier ARM surgical models, in some embodiments, an ARM surgical model may also include one or more high fidelity simulated structures disposed within the model to better mimic the properties and functionality of anatomical structures of a subject. This may include, for example, one or more reinforced simulated anatomical structures as described further below.

In some embodiments, a surgical model may be provided in a model support of the device. The model support may include an internal volume sized and shaped to receive at least a portion of the surgical model. The model support may be configured to be releasably engaged with the base, thereby allowing the surgical model to be inserted into or removed from the base. For example, the model support may cooperate with a cavity of the base, the cavity being configured to releasably receive the model support or surgical model. The model support may be formed from a rigid material (including plastic materials such as nylon, metals, and/or any other appropriate material) in order to support the surgical model. The model support may be configured to support an operating surface of the surgical model in a desired position and orientation relative to a supporting base of the device when the surgical model is engaged with the base. This may present the surgical model in a desired position and orientation such that a user of the device may perform a simulated surgical procedure on or through the operating surface of the surgical model.

An ARM repair simulation device according to the present disclosure may also be configured to position and orient a surgical model consistent with the position and orientation of a patient during an ARM repair procedure. For example, a base of a device may cooperate with a surgical model or a model support to present an operating surface of the surgical model at an angle, position, and/or orientation that simulates an angle, position, and/or orientation of a patient during a surgical procedure. This may further increase an experiential fidelity of the surgical model during training by allowing a surgeon to perform the steps of a procedure at positions and orientations relative to a supporting surface that simulate an actual operating environment that may be present during an actual procedure.

An ARM repair simulation device according to the various embodiments disclosed herein may include a surgical model configured to simulate any desired malformation. This may include at least one anorectal malformation selected from imperforate anus, rectal atresia, rectal stenosis, rectoperitoneal fistula, cloacal fistula, rectovestibular fistula, rectobulbar urethral fistula, rectoprostatic urethral fistula, rectobladder neck fistula, or any other appropriate ARM condition or combination of ARM conditions.

In addition to an ARM surgical model, as noted previously, in some embodiments, a surgical model may correspond to other types of anatomical malformations such as cleft lip or other conditions. In these surgical models it may be desirable to provide a high fidelity anatomical model that closely mimics the properties and behavior of the tissue present within an actual subject. This may improve the ability of a surgeon to practice realistic procedures due to the ability of the materials to be sectioned, sutured, clamped, and/or otherwise manipulated in a fashion that is consistent with the procedure being practiced. In some embodiments, such a surgical model may include one or more reinforced simulated tissues. Depending on the tissue being modeled, these reinforced simulated tissues may be at least partially encapsulated within a second surrounding simulated tissue, may be at least partially disposed between separate simulated tissues, may include one or more openings formed in the reinforced sections of the tissue layer to simulate one or more anatomical features which are intended to be manipulated, pulled, cut, sutured, or otherwise interacted with (e.g., anatomical lumens, etc.), or any other desired simulated tissues. Various constructions and materials related to these simulated tissues are elaborated on further below and in the figures.

As noted above, a surgical model may include various simulated tissues configured to simulate a tissue of a patient. Simulated tissues may include a simulated skin layer, a simulated muscle, a simulated fat layer, a simulated organ, a simulated bone, a simulated cartilage, a simulated tendon, a simulated tumor, a simulated blood clot, or any appropriate simulated tissue or combination of tissue or tissue layers which may simulate a normal or abnormal anatomy. Each simulated tissue may be formed from any appropriate material for simulating a normal or abnormal portion of a patient's anatomy, including various silicone materials. The materials and configurations of each simulated tissue may be selected to enhance a visual, tactile, haptic, or other operational or experiential fidelity of the surgical model. For example, in some embodiments, a simulated tissue may include a reinforcing material, such as: a flexible woven or non-woven fabric, mesh, or web that may either be elastic or substantially inextensible; a porous non-woven material such as a polymer based felt impregnated with a flexible matrix material such as silicone; or others. In instances where reinforcing materials are used in a simulated tissue, an appropriate matrix material, such as silicone or others, may be used to encapsulate, impregnate, or otherwise incorporate the reinforcing materials into the desired simulated tissue. The reinforcing material may increase a tactile or haptic fidelity of the surgical model during a simulated procedure, including during a suturing step of the simulated procedure. The disclosed reinforcements may also reduce tearing associated with physical movement, suturing, dissection, or other manipulation of the simulated tissues.

As previously noted, the various embodiments of a surgical model disclosed herein may include simulated skin layers and/or simulated organs in some embodiments. While any appropriate type of simulated tissue may be used, in some embodiments, a simulated skin layer and/or simulated organ may include silicone with a durometer reading that is between or equal to Shore 00-0 and Shore A-30. In some embodiments, a simulated skin layer may preferably include silicone with a durometer reading that is between or equal to Shore 00-10 and Shore 00-50. In some embodiments, a simulated organ may preferably include silicone with a durometer reading that is between or equal to Shore 00-0 and Shore 00-30. In some instances it may be desirable to include one or more reinforcements within a simulated skin layer or simulated organ. The one or more reinforcements may include any of the reinforcement materials described herein, but in some embodiments, a simulated skin layer may include an elastic reinforcement such as an elastic woven or non-woven fabric, mesh, or web. In one specific embodiment, this may include an elastic nylon mesh. In either case, a reinforcement material may be encapsulated in and extend at least partially across an area of simulated anatomy formed by the silicone. In the case of an organ, the reinforcement may be located in a portion of the simulated organ that is manipulated during use and/or associated with anatomical structures such as lumens found in the simulated anatomy, as elaborated on further below. Depending on the particular structure being simulated, a simulated skin layer may have any desired thickness, including a thickness between or equal to 1 mm and 3 mm. Alternatively, a thickness of a simulated skin layer may be between or equal to 2.25 mm and 2.75 mm, or more preferably about 2.5 mm. However, other appropriate thicknesses both greater and less than those noted above may also be used as the disclosure is not so limited. Depending on the organ being simulated, a simulated organ may have any appropriate size and/or shape. A simulated skin layer and/or organ may also have appropriate pigmentation to simulate a desired coloration in some embodiments. Appropriate pigments may include various hues of pink, brown, and/or any other appropriate coloration.

The various embodiments of a surgical model disclosed herein may include one or more simulated muscles in some embodiments. While any appropriate type of simulated muscle may be used, in some embodiments, the simulated muscle includes a silicone material with a durometer reading that is between or equal to Shore 00-0 and Shore A-30. The durometer reading of the silicone may preferably be between or equal to Shore 00-10 and Shore 00-50 in some applications. In some instances it may be desirable to include one or more reinforcements within a simulated muscle. Depending on the specific muscle being simulated, different types of reinforcements may be used to mimic a behavior of the tissue being simulated. For example, certain muscle groups encountered during different surgical procedures may exhibit a different tactile feel to a surgeon during an operation. Accordingly, in some embodiments, the one or more reinforcements may include an elastic reinforcement such as an elastic woven or non-woven fabric, mesh, or web encapsulated in and extending at least partially across an area of simulated muscle formed by the corresponding layer of silicone. In another embodiment, a simulated muscle may correspond to a porous non-woven material impregnated with silicone. For example, this may include a non-woven felt, such as a polyester felt, with one or more desired dimensions (e.g., thickness, length, and width), that has been impregnated with the silicone material. Appropriate thicknesses for the porous non-woven material may be between or equal to 1 mm and 2 mm. Depending on the particular structure being simulated a simulated muscle may have any desired thickness, length, and/or width. While specific dimensions associated with a simulated muscle are described above, other appropriate dimensions both greater and less than those noted above may also be used as the disclosure is not so limited. A simulated muscle may also have appropriate pigmentation to simulate a desired muscle coloration in some embodiments. Appropriate pigments may include various hues of red and/or any other appropriate coloration.

The various embodiments of a surgical model disclosed herein may include a simulated fat layer in some embodiments. Depending on the type of fat and location within the body, fat may exhibit different characteristics. Therefore, in some embodiments, a simulated fat layer may include a silicone material with a durometer reading that is between or equal to Shore 00-0 and Shore A-30. The durometer reading of the silicone may preferably be between or equal to Shore A-0 and Shore A-30 in some applications. In other embodiments, such as in an ARM surgical model, a softer fat layer may be desired. In such an embodiment, various additives and/or fillers may be included to provide increased flexibility and/or viscoelastic properties relative to the other simulated tissues. These properties may provide for improved ability to create incisions in and permit retraction of the simulated fat layer during a simulated surgical procedure. Appropriate additives and/or fillers may include but are not limited to: viscosity modifiers (e.g., tactile mutators such as Slacker sold by Reynolds Advanced Materials to provide a desired flesh like feel to the silicone) to modify a viscoelasticity of the simulated tissue (e.g., a simulated fat layer); thickening agents such as THI-VEX®-Thixotropic Agent; fillers such as cornstarch and/or any other appropriate additive and/or filler. In some embodiments, an additive such as mineral oil or others may be included to reduce or control a durometer or tackiness of the silicone. In some embodiments, a simulated fat layer may include silicone with an unmodified durometer reading between or equal to Shore A-0 and Shore A-30 when unmodified by additives and/or fillers.

The various embodiments of a surgical model disclosed herein may include a simulated bone and/or cartilage layer in some embodiments. Appropriate materials for a bone and/or cartilage layer may include rigid polymers such as nylon, polyethylene, polyurethane, and/or any other desired material. The size and/or shape of a simulated bone and/or cartilage layer may be selected based on the desired anatomical features being simulated in a given surgical model. Additionally, in some embodiments, a surgical model may not include any simulated bone and/or cartilage layers.

In view of the above descriptions of the various layers that may be included in a surgical model, the various layers may exhibit different relative tactile feels for a surgeon operating on the surgical model. For example, in the various embodiments described herein, a simulated muscle may exhibit a desired set of characteristics relative to a simulated skin layer. For example, interactions between a simulated muscle and a simulated skin layer may mimic an interaction between an actual muscle and an actual skin layer in terms the relative rigidity, elasticity, or other visual, tactile, haptic, or operational characteristic, as will be appreciated by one of skill in the art. Correspondingly, a simulated fat layer may be less rigid than both a simulated skin layer and muscle of a surgical model to help simulate the relatively softer feel of fat during a surgical procedure. In embodiments including simulated bone and/or cartilage, the simulated bone and/or cartilage may be more rigid than the corresponding simulated skin, muscle, and fat layers of the surgical model. For example, interactions between or among a simulated fat layer, a simulated cartilage, and/or a simulated bone may mimic an interaction between the various tissues in terms their relative rigidities, elasticities, or other visual, tactile, haptic, or operational characteristics, as will be appreciated by one of skill in the art. Additionally, while specific materials and properties are provided for the various simulated tissues above, it should be understood that simulated tissues including materials and/or properties different from those discussed above are also contemplated as the disclosure is not so limited.

The surgical models disclosed herein are primarily directed to cleft lip and anorectal malformations. Accordingly, in some embodiments, the surgical models may be sized and shaped to simulate the anatomy of a child and/or infant. However, the disclosure is not limited to only simulating the anatomy of a child. Accordingly, it should be understood that the surgical models disclosed herein may correspond to simulated anatomies of subjects with any appropriate age including, but not limited to, infants, children, juveniles, and adults.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

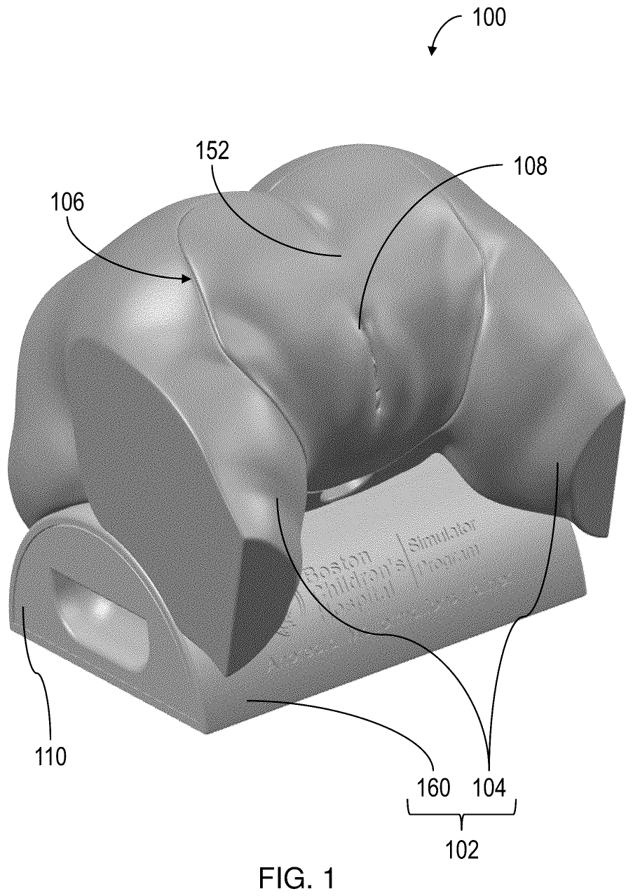

FIG. 1 depicts an anorectal malformation (ARM) repair simulation device 100 according to the present disclosure. The device 100 may include a base 102 and a surgical model 106. The base 102 may be configured to rest on a surface (not shown) and to support, retain, orient, or position the surgical model 106 during use or storage.

In some embodiments, a base 102 may include a stand portion 160. The stand portion 160 may be configured to support, retain, orient, or position other portions of the base 102, including one or more anatomical structures 104 of the base as will be described below. In some embodiments, a stand portion may additionally or alternatively be configured to support, retain, orient, or position other portions of the device 100, including a surgical model 106 or a model support in which a surgical model may be retained.

In some embodiments, one or more portions of the base 102 may be sized and shaped to simulate one or more anatomical structures. For example, the base 102 may include one or more external anatomical structures 104. In various embodiments, the external anatomical structures 104 may include one or more legs (or portions thereof), a pelvic region, a genital region, a posterior region, an abdominal region, a spinal region, combinations of the forgoing, and/or any other appropriate anatomical structure or combination of anatomical structures. In the embodiment shown, the base 102 may include portions of a first leg and second leg disposed on either side of a pelvic region. The base may also include portions of a posterior region, and portions of an abdominal region in some embodiments. In other embodiments, the base may additionally or alternatively include any other appropriate external or internal anatomical structures. In some embodiments, the anatomical structures 104 may be configured to support, retain, orient, or position other portions of the device 100, including a surgical model 106 or a model support in which a surgical model may be retained.

A base 102 and any components or portions thereof (including a stand portion and any anatomical structures of the base) may be formed from any appropriate material, including rigid plastic materials such as nylon, polyethylene, polyurethane, acrylonitrile butadiene styrene (ABS), polycarbonate (PC), or any other appropriate plastic or non-plastic material. Portions of a base may alternatively or additionally be formed from more flexible materials such as silicone, rubber, or any other appropriate flexible material. Combinations of rigid and flexible materials are also contemplated. For example, a stand portion of a base may be formed from a rigid material while an anatomical structure of the base may be fully or partially formed from a flexible material to more accurately simulate a surgical experience of a surgeon or user. The base may be manufactured using any appropriate manufacturing method, including additive manufacturing methods, molding methods, subtractive manufacturing methods (e.g., machining), and/or any other appropriate method or combination of methods.

It will be appreciated that although the embodiment shown includes a base 102 having both a stand portion 160 and multiple anatomical structures 104 disposed thereon, other configurations are also contemplated as the disclosure is not limited in this regard. For example, in various embodiments, a base may include only a stand portion or only one or more anatomical structures as appropriate for a given application. The present disclosure further contemplates that, in addition to a stand portion or any anatomical structures, a base may include any further support structures which may be appropriate for supporting, retaining, orienting, or positioning a surgical model on the base. In embodiments which include a base having multiple portions, the various portions of the base may be manufactured as a single piece (e.g., through an additive manufacturing or molding process), or may be manufactured as separated pieces and joined together permanently, semi-permanently, or releasably. For example, one or more anatomical structures of a base may be joined to a stand portion of a base using adhesives, fasteners (including threaded fasteners), snaps, latches, clips, detents, magnets, or any other appropriate type of connection depending on the embodiment.

In some embodiments, the base 102 (or a stand portion thereof) may optionally include a space for storing items such as surgical tools or equipment. For example, in the embodiment shown, the stand portion 160 of the base 102 may include a drawer 110. The drawer 110 may include an open internal volume and may be configured to slide into and out of the base 102 to expose the internal volume. The internal volume may be configured to house various items, tools, or equipment.

A surgical model 106 of the device 100 may be configured to simulate a portion of a patient's anatomy to be repaired during a simulated medical procedure. The surgical model 106 may include an operating surface 152. A surgeon or user may perform a simulated surgical procedure or steps of a simulated surgical procedure on the operating surface 152 or through the operating surface. The surgical model 106 and/or the operating surface 152 may include a simulated malformation or other condition of a patient's anatomy, including a simulated anorectal malformation (ARM) 108. In various embodiments, a simulated ARM 108 may include an imperforate anus, a rectal atresia, a rectal stenosis, a rectoperitoneal fistula, a cloacal fistula, a rectovestibular fistula, a rectobulbar urethral fistula, a rectoprostatic urethral fistula, a rectobladder neck fistula, or any other appropriate ARM condition or combination of ARM conditions. For example, in the embodiment shown, the simulated ARM 108 may include a rectovestibular fistula. As will be described further below, the surgical model 106 and simulated ARM 108 may comprise one or more simulated tissues arranged or configured to simulate a desired condition.

The surgical model 106 may be configured to be releasably engaged with the base 102 or a portion thereof (including a stand portion or an anatomical structure of the base), such that the surgical model 106 may be removed from the base 102 and replaced with another surgical model. In some embodiments, the surgical model 106 may be provided within or in cooperation with a model support. As will be described further below, a model support may be a rigid structure configured to house, retain, or support the surgical model 106. In some embodiments, the model support may include an internal volume sized and shaped to receive at least a portion of the surgical model disposed therein. Additionally, the model support may be configured to be releasably engaged with the base 102, or to facilitate the releasable engagement of the surgical model 106 with the base 102.

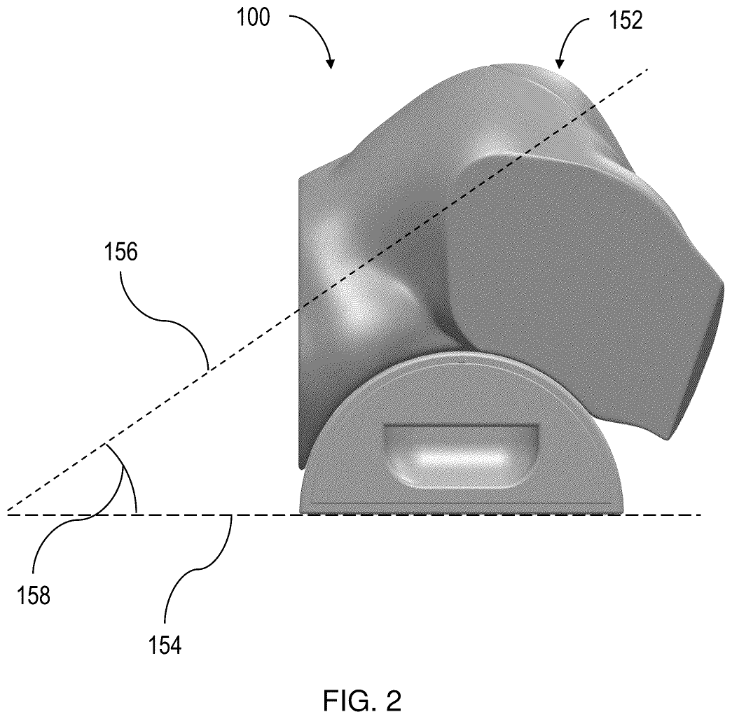

As best shown in FIG. 2, the base 102 (or components thereof, including a stand portion or anatomical structures of the base), the surgical model 106, and/or the model support may be configured to present an operating surface 152 of the surgical model 106 at an angle, position, or orientation that may simulate an angle, position, or orientation of a patient during a procedure. In some embodiments and as shown in FIG. 2, the device 100 may be configured to present the operating surface 152 at an angle relative to an underlying surface 154 on which the base 102 may be disposed. In the embodiment shown, a sagittal axis 156 of a simulated patient of the device 100 may be disposed at an angle 158 with respect to the underlying surface 154 in order to simulate a position of a patient during a surgical procedure.

In some embodiments, the angle 158 between a sagittal axis of an ARM surgical model and an underlying surface the base of the device is disposed on may be greater than or equal to 15°, 30°, 45°, and/or any other appropriate angle. Additionally, the angle may be less than or equal to 90°, 60°, 45° and/or any other appropriate angle. Combinations of the foregoing are contemplated including, for example, an angle that is between or equal to 20° and 60°. Of course, while particular ranges for the angle between the sagittal axis and the underlying surface are provided above, it should be understood that other ranges both greater than and less than those noted above are also contemplated as the disclosure is not limited in this fashion.

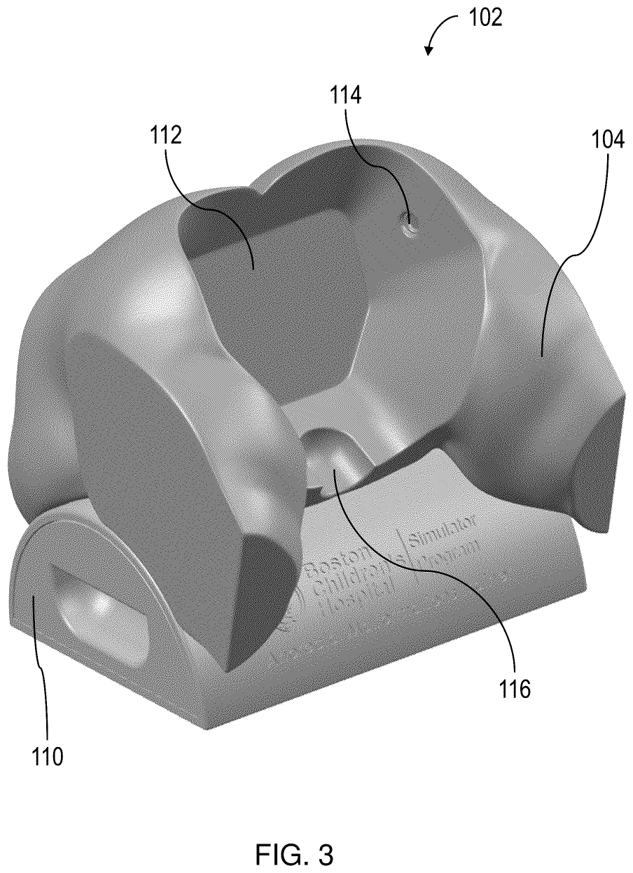

As shown in FIG. 3, the base 102 may include a cavity 112 formed therein. The cavity 112 may be sized and shaped to retain a surgical model 106 or a model support with a surgical model contained at least partially therein. The cavity 112 may include one or more releasable connectors 114 such that the cavity may releasably receive the surgical model or model support. A releasable connector 114 may be a snap, latch, clip, clamp, detent, spring plunger, magnet, or any other appropriately releasable connector as the disclosure is not limited in this regard. The cavity 112 may further include a cutout 116 configured to facilitate removal and replacement of a surgical model or model support. The cutout 116 may be sized and shaped to accommodate one or more fingers of a user, or an appropriate tool, to enable the user to grip and/or apply an appropriately directed force to the surgical model or model support when removing and/or inserting the surgical model or model support. It will be appreciated that a cavity 112 may be included in any portion of a base, including a stand portion or an anatomical structure of the base.

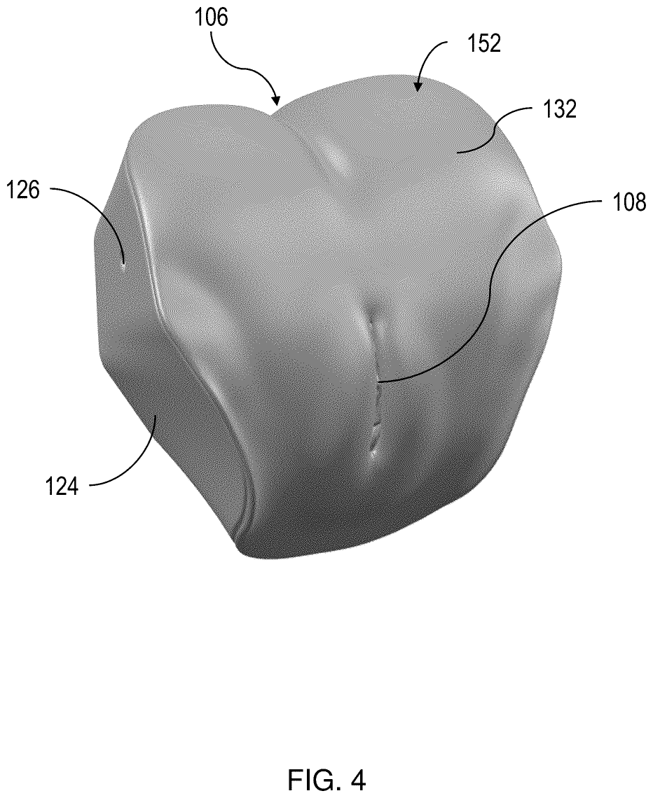

FIG. 4 depicts one embodiment of a surgical model 106 disposed within a model support 124. As noted above, the model support 124 may be a rigid structure configured to house, retain, and/or support the surgical model 106. For example, in the depicted embodiment, the model support is sized and shaped such that at least a portion of the surgical model is disposed within an internal cavity of the model support with a desired operating surface 152 oriented outwards from the model support such that a user may interact with the operating surface. In some embodiments, the model support may be formed from any appropriate material, including rigid plastic materials such as nylon, polyethylene, polyurethane, acrylonitrile butadiene styrene (ABS), polycarbonate (PC), or any other appropriate plastic or non-plastic material. The model support may be manufactured using any appropriate manufacturing method, including additive manufacturing methods, molding methods, subtractive manufacturing methods (e.g., machining), or any other appropriate method or combination of methods.

In some embodiments, the model support may be configured to be releasably engaged with the base 102, or to facilitate the releasable engagement of the surgical model 106 with the base 102. For example, the model support 124 may include one or more releasable connections 126 configured to cooperate with the one or more corresponding releasable connections 114 of the base. In various embodiments, a releasable connection may be cooperating portions of a snap, latch, clip, clamp, detent, spring plunger, magnetic connection, or any other appropriate releasable connection as the disclosure is not limited in this regard. For example, in some embodiments, a releasable connection may comprise a corresponding spring plunger and indentation located on the model support and base. In such an arrangement, the indentation may be sized, shaped, and positioned to selectively engage the spring plunger of the base in order to provide a releasable press fit to retain the model support within the base. However, as noted above, other appropriate releasable connections may also be used.

As noted above, the surgical model 106 may include one or more simulated tissues. For example, a surgical model may include one or more of a simulated skin layer, a simulated muscle, a simulated fat layer, and a simulated organ, or any appropriate tissue layer or combination of layers. In some embodiments, the one or more simulated tissues may form an operating surface as described above. For example, in the embodiment of FIG. 4, an operating surface 152 may be formed at least by a simulated skin layer 132. The simulated skin layer 132 or operating surface may include a malformation or condition to be repaired during a simulated surgical procedure. For example, in the embodiment shown, the simulated skin layer 132, and other associated layers as elaborated on below, may include a simulated anorectal malformation (ARM) 108. It will be appreciated that, in some embodiments, a malformation or condition may be formed below the operating surface or within an interior of the surgical model 106 such that the malformation is not externally visible or apparent.

Each simulated tissue, including the simulated skin layer 132, may be formed from any appropriate material or combination of materials for simulating a portion of a patient's anatomy as detailed above. The materials and configurations of each simulated tissue may be selected to enhance a visual, tactile, haptic, or other operational or experiential fidelity of the surgical model. For example, in some embodiments, a simulated tissue may include a reinforcing material to increase a tactile or haptic fidelity of the surgical model during a simulated procedure, including during a suturing step or a sectioning step of the simulated procedure. Additionally, the reinforcing material may reduce tearing of the surgical model or simulated tissue during the simulated procedure, for example during a tissue retraction step, a suturing step or a sectioning step.

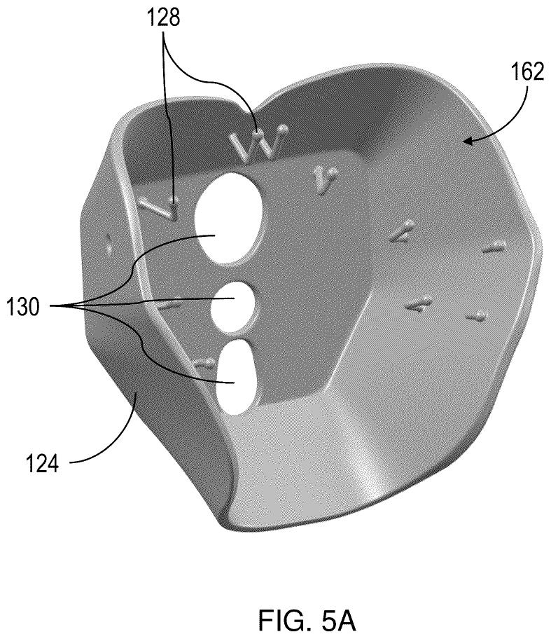

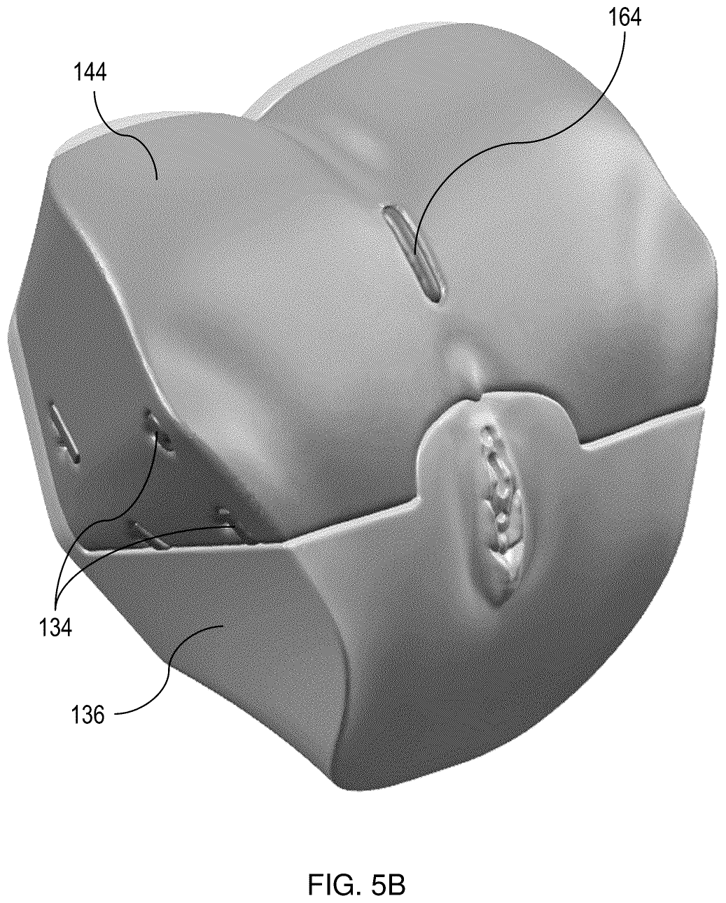

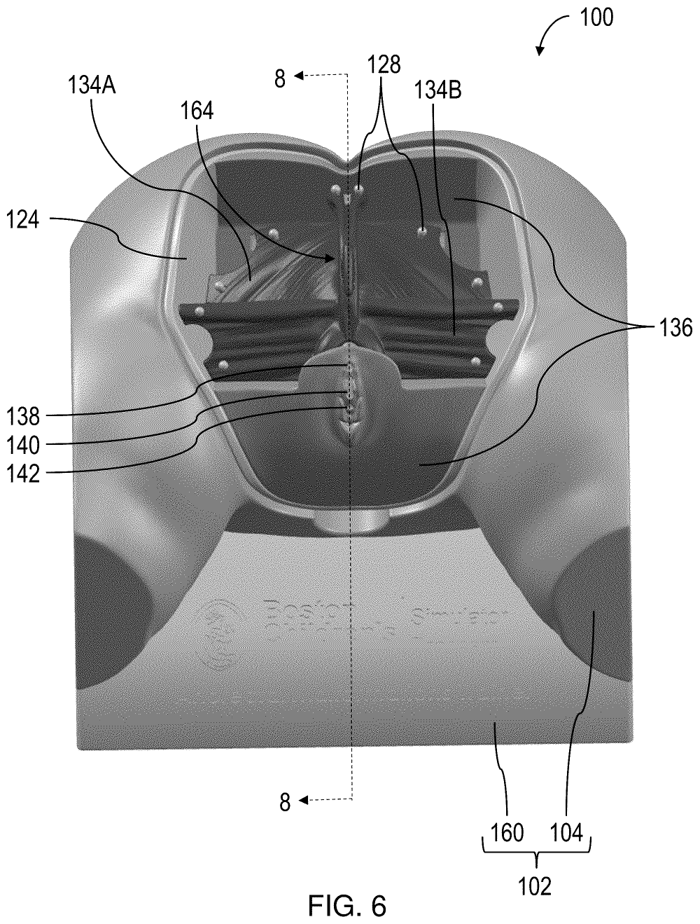

As shown in FIG. 5A, in some embodiments, the model support 124 may include an internal volume 162 sized and shaped to receive at least a portion of the surgical model 106. The model support 124 or internal volume 162 may additionally include one or more tissue retainers 128 configured to support, retain, or position one or more simulated tissues within the surgical model 106. The tissue retainers 128 may provide anchor points that may be configured to connect to and support a simulated tissue (e.g., a simulated muscle), allowing one or more simulated tissues to be anchored to the model support 124 and suspended within the model support or within another simulated tissue. FIG. 5B illustrates a surgical model where simulated muscles 134 are disposed in an interior portion of a simulated fat layer 144 adjacent to a simulated organ. The use and function of the tissue retainers 128 to permit the positioning of the simulated muscles, or other simulated tissue, in a desired position and orientation within another simulated tissue will be described in more detail in the description of FIG. 6 below.

Also shown in FIG. 5A, in some embodiments, the model support 124 may optionally include one or more through-holes 130 configured to simulate or correspond to various anatomical structures of the surgical model 106. For example, in the embodiment shown, the through-holes 130 may be configured to correspond to a rectal cavity, a vaginal cavity, and a bladder cavity which may be internal to the surgical model 106. The through-holes 130 may be included to facilitate insertion of one or more components into the internal volume of the model support during a formation process to more accurately simulate the structure of an anatomical structure or cavity within the surgical model. Additionally, the through-holes 130 may enhance a visual, tactile, haptic, or other operational or experiential fidelity of the surgical model. For example, in some embodiments, the through-holes 130 may enhance a collapsibility or deformability of an anatomical cavity to better mimic the simulated anatomy.

FIG. 6 depicts one embodiment of a device 100 with a surgical model retained within a model support 124 and inserted into a base 102. The surgical model of the embodiment of FIG. 6 has had the simulated skin layer and a simulated fat layer removed to show a simulated organ 136, a first simulated muscle 134A, and a second simulated muscle 134B within the surgical model. In the embodiment shown, the model support 124 may be inserted into the base 102 and releasably engaged with the base 102, for example via the releasable connections described above.

In some embodiments, at least one simulated organ 136 may be included to simulate at least part of an anatomy with an anatomical malformation to be repaired during a simulated surgical procedure. For example, in the embodiment shown, the simulated organ 136 may include an anal canal 138, a vaginal canal 140, and a urinary tract 142. It will be appreciated that in other embodiments, any appropriate anatomical structure, including either male or female anatomical structures or combinations thereof, may be included to simulate a desired malformation or anatomy as the disclosure is not limited to the depicted embodiment.

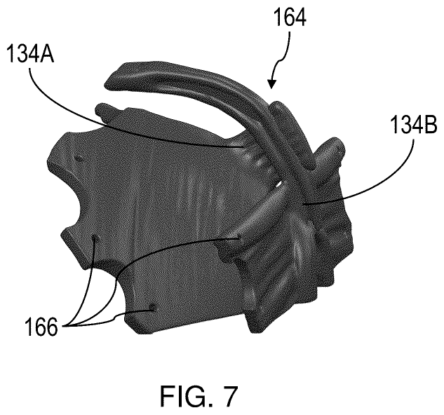

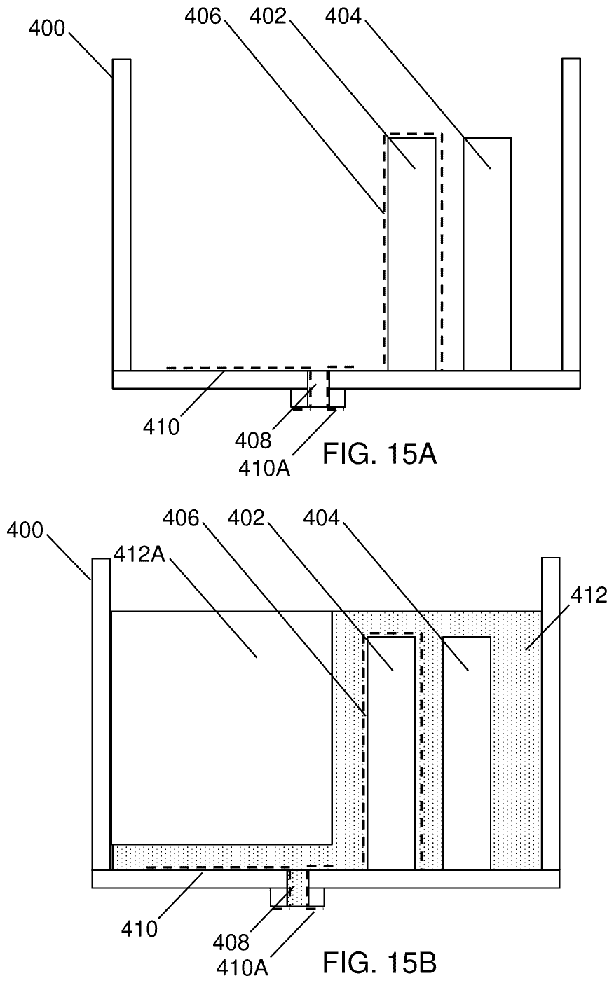

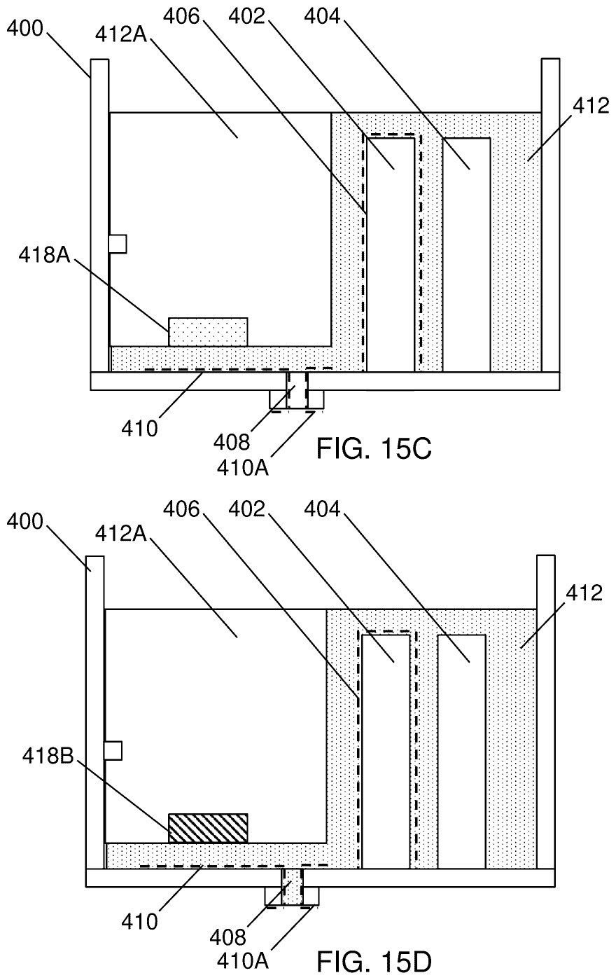

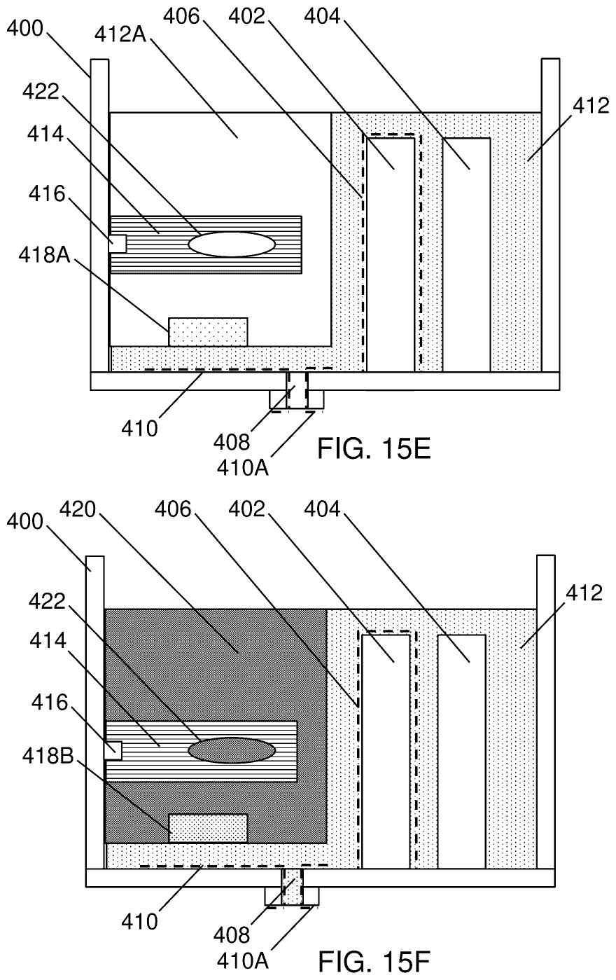

In some embodiments, at least one simulated muscle may be included to simulate at least part of an anatomy or an anatomical malformation to be repaired during a simulated surgical procedure. For example, in the embodiment shown, the first simulated muscle 134A and the second simulated muscle 134B may be provided to simulate a malformed sphincter 164. As shown more clearly in FIG. 7, the malformed sphincter 164 may be formed cooperatively by the first and second simulated muscles 134A, 134B, for example at an intersection of the first and second simulated muscles. In the embodiments of FIGS. 6 and 7, the malformed sphincter 164 may be formed by a simulated internal sphincter muscle of the first simulated muscle 134A extending through an opening formed in the simulated external sphincter muscle of the second simulated muscles layer 134B. As illustrated in the figure, the simulated muscles may include openings formed therein and elongated portions which may include different forms of reinforcement as elaborated on further below. For example a portion of the first simulated muscle and the portion of the second simulated muscle including an opening formed therethrough for accepting the portion of the first simulated muscle may include different arrangements of the reinforcing materials. Similarly elongated portions of the simulated muscles may include different reinforcing materials as well as elaborated on further below relative to FIGS. 15A-15F and elsewhere.

As shown in FIG. 6, each of the first and second simulated muscles 134A, 134B may be retained within the model in a desired position and orientation within the fat layer (not depicted) using one or more tissue retainers 128 engaged with the first and second simulated muscles. The tissue layer retainers may be any appropriate retainer for supporting, suspending, securing, or otherwise retaining a simulated tissue within a surgical model or a model support of the current disclosure. In various embodiments, the tissue layer retainers may comprise hooks, clips, latches, clamps, fasteners, or any other appropriate type of connection. For example, in the embodiment shown, each of the tissue retainers 128 comprises a hook configured to engage with a respective suspension hole 166 (shown in FIG. 7) formed in the appropriate muscle, allowing each muscle to be suspended within the retainer by the plurality of hooks shown.

Each simulated tissue (including the simulated muscles 134A, 134B, and the simulated organ 136 (as well as a simulated skin layer and a simulated fat layer) may be molded or otherwise manufactured using various flexible materials (e.g., silicones, rubbers, or others) and may optionally include a reinforcing material as described herein to provide a realistic haptic, tactile, or other surgical experience for a user of the device 100. During manufacture of some embodiments, the suspension of one or more simulated tissues as depicted in FIG. 6 may allow other simulated tissues to be formed around the suspended tissue layer(s) such that a first tissue, such as a simulated muscle, organ, or other tissue, may be encapsulated within, or otherwise arranged relative to, a second tissue layer in a desired position and orientation. For example, a simulated muscle may be molded separately and then suspended within a model support while a simulated fat layer may be formed around the muscle (e.g., by molding the simulated fat layer around at least a portion of the simulated muscle). This may allow the simulated fat layer to at least partially, and in some instances, fully surround the simulated muscle in order to accurately simulate a patient's anatomy.

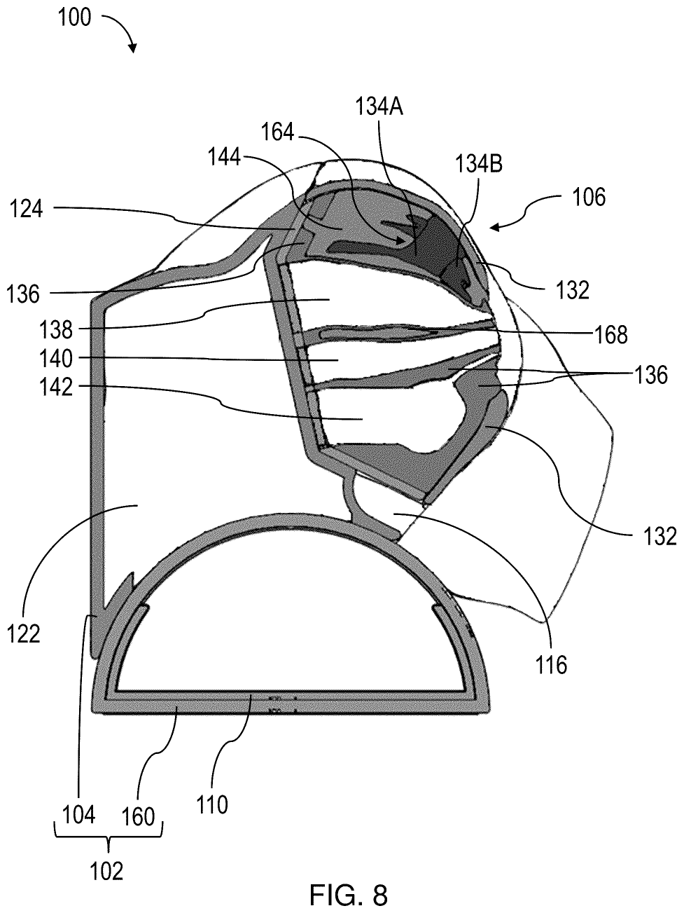

FIG. 8 depicts a cross-section of the device 100 of FIG. 6 taken along the line 8-8. The cross-sectional view includes the simulated fat layer 144 and the simulated skin layer 132 which had been removed from the view of FIG. 6. In the embodiment shown, the surgical model 106 may include a simulated skin layer 132, a first simulated muscle 134A, a second simulated muscle 134B, a simulated organ 136, and a simulated fat layer 144. As described above, the first simulated muscle 134A may include a malformed external anal sphincter within the parasagittal fibers of the second simulated muscle 134B to form a malformed sphincter 164. The simulated fat layer 144 may be formed around at least a portion of the first and second simulated muscles 134A, 134B and the simulated organ 136 such that the simulated muscles and organ are at least partially embedded in the simulated fat layer. The simulated skin layer 132 may be overlaid or overmolded onto the simulated muscles, simulated fat layer, and simulated organ to form an operating surface as described above.

As with previously-depicted embodiments, the embodiment of FIG. 8 may include a surgical model 106 simulating a rectovestibular fistula. It will be appreciated that other embodiments may include surgical models simulating other malformations or conditions, including other anorectal malformations as described herein. In the embodiment of FIG. 8, the surgical model 106 may be configured to simulate the ARM using the simulated tissues. For example, the simulated organ 136 may include an anal canal 138 and a vaginal canal 140. The anal canal 138 and the vaginal canal 140 may be partially conjoined by a shared wall 168 in order to simulate the rectovestibular fistula of the presently-depicted embodiment. In operation, a user may dissect the shared wall 168 in order to separate the anal canal 138 from the vaginal canal 140.

Additionally, the first and second simulated muscles 134A, 134B may be configured to simulate a portion of the desired malformation. For example, the internal sphincter muscle of the first simulated muscle 134A may be formed as a single continuous muscle, without a space in which an anus would be formed. Similarly, the simulated skin layer 132 may be formed to be continuous over the simulated muscles, without a space through which an anus may extend. In such embodiments, the user may dissect the simulated skin layer 132 and the first simulated muscle 134A in order to create a space in which a repaired anus may be formed. After separating the anal canal 138 from the vaginal canal 140 as described above, the user may relocate the anal canal 138 into the spaces formed in the simulated skin layer 132 and the first simulated muscle 134A to form a repaired anus.

A surgical model 106 may optionally include other anatomical structures which may or may not be included in a simulated malformation or in a simulated surgical procedure. For example, in the embodiment shown, the simulated organ may include a urinary tract 142 or a cavity disposed in the simulated organ structure(s) to simulate a bladder of a patient. Although these additional anatomical structures may not be within the scope of the simulated surgical procedure, their optional inclusion in the surgical model may enhance a visual, tactile, haptic, or other operational or experiential fidelity of the surgical model.

Further, in the embodiment shown, the base 102 or a stand portion 160 of the base 102 may include a drawer 110 configured to slide into and out of the base as described above. The base 102 may also include anatomical structures 104 as described above. The base 102 may further include a hollow portion 122 to reduce a weight or a manufacturing cost of the device 100. Additionally, the base may include a cutout 116 to facilitate insertion and removal of a surgical model or model support of the device as described above.

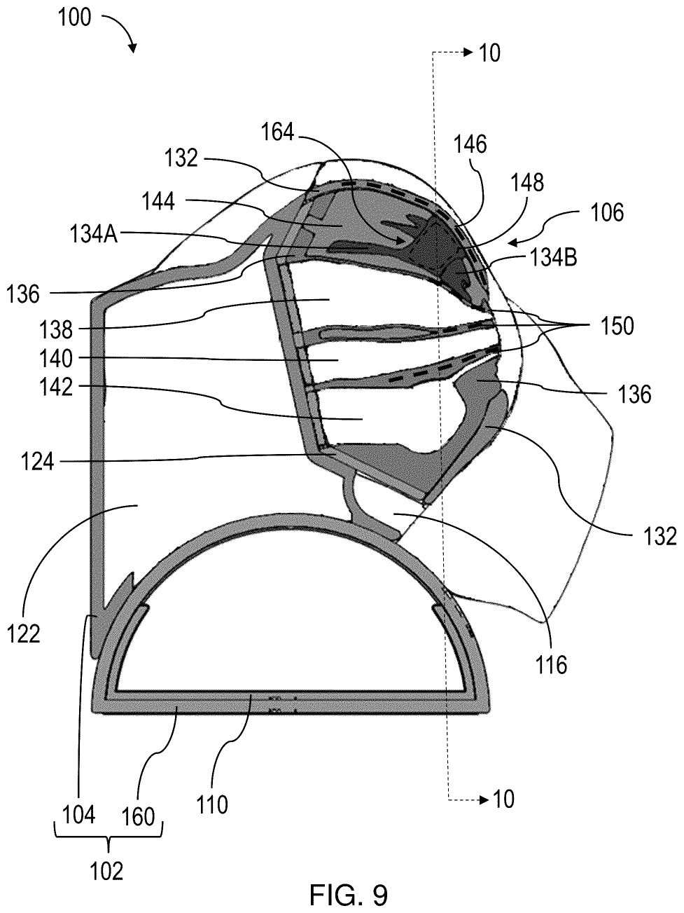

The embodiment of FIG. 9 is substantially similar to the embodiment of FIG. 8 with the exception that the embodiment of FIG. 9 may include one or more reinforcing materials in one or more of the simulated tissues. As noted above, reinforcing material in a simulated tissue may increase a tactile or haptic fidelity of the surgical model during a simulated procedure, including during a suturing step or a sectioning step of the simulated procedure. Additionally, the reinforcing material may reduce tearing of the surgical model or simulated tissue during the simulated procedure, for example during a suturing step or a sectioning step. The reinforcing material may be any appropriate material as described above for the particular tissue being simulated.

In some embodiments, a simulated tissue may include a reinforcing material throughout the entire layer. Additionally or alternative, a simulated tissue may include a reinforcing material only in areas where certain steps of a simulated surgical procedure are to be performed. For example, in some embodiments, a simulated tissue may include a reinforcing material only in areas where sutures are to be placed through the simulated tissue. In the embodiment shown, at least one skin reinforcement 146 may be included in the simulated skin layer 132 in the area of the malformed sphincter 164. Similarly, at least one muscle reinforcement 148 may be included in the area of the first simulated muscle 134A in which the repaired anus is to be formed as described above. Additionally or alternatively, one or more organ reinforcements 150 may be included in the simulated organ in the areas of the anal canal 138 and/or the vaginal canal 140.

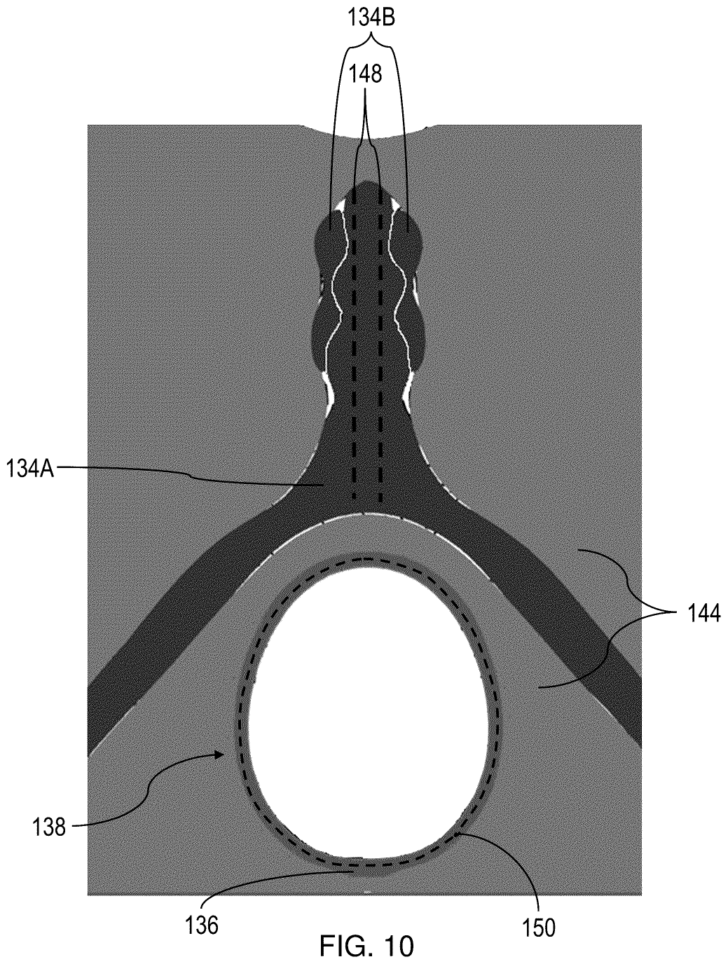

FIG. 10 depicts a close-up cross-sectional view of the rectovestibular malformation of the embodiment of FIG. 9 taken along line 10-10. As noted above, a reinforcing material may be included in an area in which one or more steps of a simulated procedure are to be performed. For example, in the embodiment of FIG. 10, the muscle reinforcement 148 may be included in the area of the first simulated muscle 134A in which the repaired anus is to be formed. As described above, the repaired anus may be formed in part by dissecting the first simulated muscle 134A in order to create a space through which the separate anal canal 138 may be inserted. In such embodiments, a muscle reinforcement 148 may be configured to facilitate a dissection of the first simulated muscle 134A. For example, in the embodiment of FIG. 10, the muscle reinforcement 148 may be provided, either as a single piece or as multiple pieces of a reinforcing material extending along either side of at least a portion of the first simulated muscle 134A which is to be dissected. This may facilitate dissection by allowing a user to cut into an interior space between the two sides of the muscle reinforcement 148. The muscle reinforcement 148 may thereby reduce a risk of tearing the first simulated muscle 134A and may provide a more realistic training experience for the user.

Additionally or alternatively, an organ reinforcement may be provided within a simulated organ extending both at least partially, and in some instances entirely, around a perimeter and along a length of a simulated anatomical structure, including, for example, a simulated lumen. The reinforcing material of the organ reinforcement may correspond to a flexible tube that is embedded in the flexible matrix of the simulated tissue which may correspond to a simulated organ in the depicted embodiment. For example, in the embodiment of FIG. 10, the organ reinforcement 150 may be provided within the simulated organ 136 around a perimeter and length of the anal canal 138. This may facilitate separation of the anal canal 138 from the vaginal canal 140 as described above and may reduce a risk of tearing the anal canal 138 during dissection and relocation of the anal canal 138. Additionally, the organ reinforcement 150 and/or the muscle reinforcement 148 may provide a more realistic haptic experience during steps of the repair procedure which may include suturing of the anal canal 138 or the first simulated muscle 134A, respectively.

FIG. 11 depicts another cross section of a surgical model 106 similar to those described above. In the depicted embodiment, the surgical model includes a simulated skin layer 132, simulated fat layer 144, simulated muscles 134A and 134B, as well as the simulated organ 136 including lumens corresponding to the rectum 138, vaginal canal 140, and bladder cavity 142. The figure better illustrates the positioning of the first simulated muscle 134A extending around the simulated rectum with the fat layer 144 disposed therebetween. The various reinforcements are also well illustrated in this figure. Specifically, a skin reinforcement 146 is shown as extending across at least a portion of the simulated skin layer 132. Similarly, a muscle reinforcement 148 extends across at least a portion of the simulated muscle that will be subject to a simulated surgical procedure during use of the surgical model. The separate organ reinforcements 150 are depicted as extending around a perimeter of the simulated lumens correspond to the rectum and vaginal cavity. The depicted bladder cavity is not reinforced, though embodiments in which other lumens are reinforced are also contemplated.

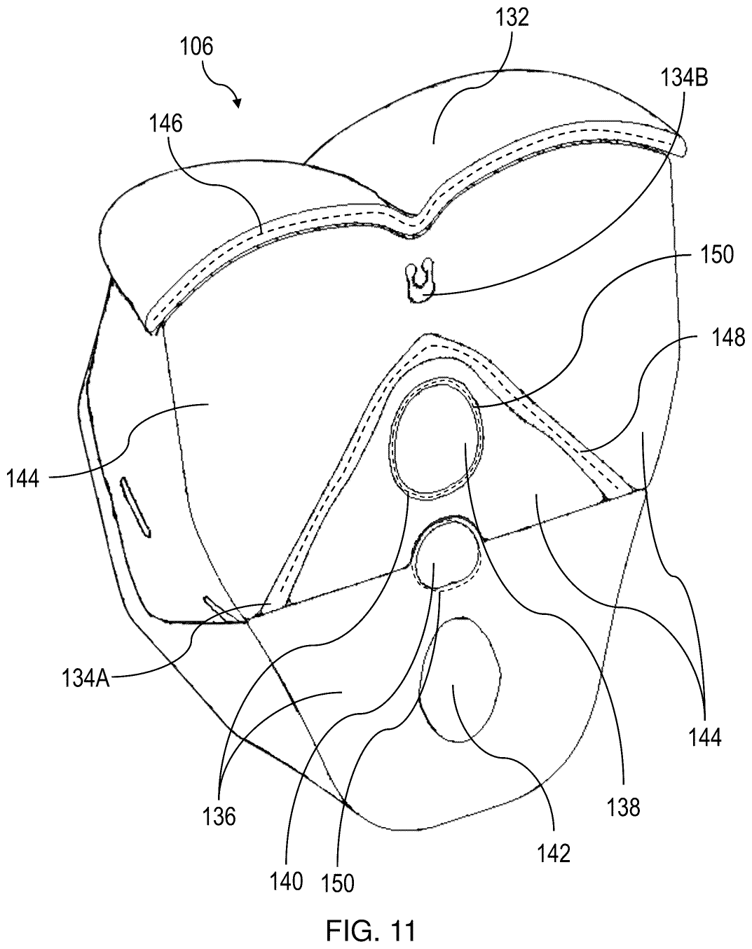

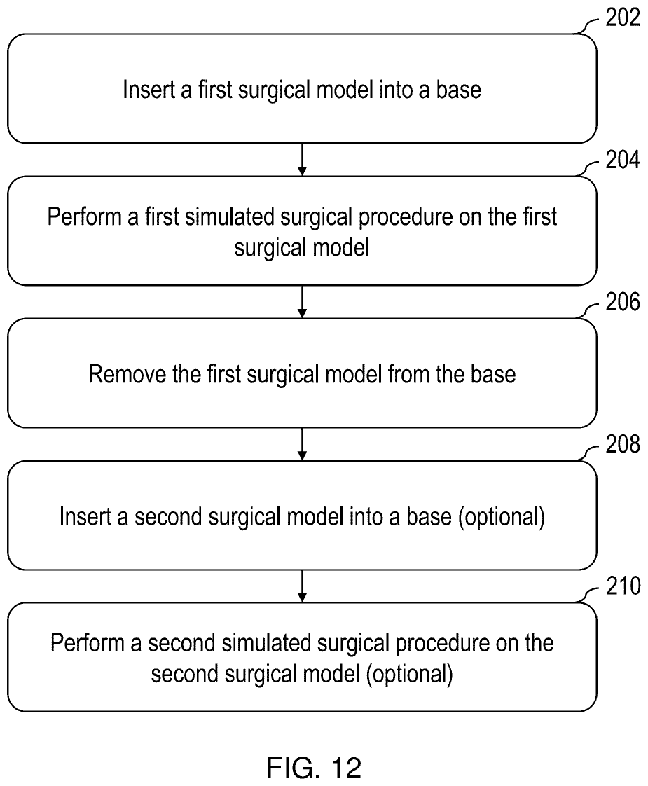

FIG. 12 depicts a method of surgical simulation according to the present disclosure. At step 202, a first surgical model of a malformation repair simulation device may be inserted into a base of the device as described herein. In some embodiments, the first surgical model may be configured to simulate an anorectal malformation (ARM), including an imperforate anus, a rectal atresia, a rectal stenosis, a rectoperitoneal fistula, a cloacal fistula, a rectovestibular fistula, a rectobulbar urethral fistula, a rectoprostatic urethral fistula, a rectobladder neck fistula, or any other appropriate ARM or combination of ARM conditions. The first surgical model may be disposed on or supported by a first model support as described above. Accordingly, step 202 may optionally include inserting a first model support into the base. In some embodiments, the base may include a cavity configured to releasably receive a surgical model or model support. Inserting a first surgical model or first model support may include releasably engaging the first surgical model or first model support, for example using one or more releasable connectors of the base (or cavity of the base) in conjunction with one or more releasable connection points of the first surgical model or first model support as described above.

At step 204, a first simulated surgical procedure may be performed on the first surgical model. This may include performing one or more simulated procedure steps on one or more simulated tissues of the first surgical model. As described above, the one or more simulated tissues may include at least one of a simulated skin layer, a simulated muscle, a simulated fat layer, a simulated organ, or any combination thereof. In embodiments which include the use of a reinforcing material in one more simulated tissues, performing the first simulated surgical procedure or performing the one or more simulated procedure steps may include dissection and/or suturing of one or more of the simulated tissues in an area that includes the reinforcing material.

At step 206, the first surgical model may be removed from the base. In embodiments which include a first model support, step 206 may optionally include removing the first model support from the base. Removing a first surgical model or first model support may include using the one or more releasable connectors of the base in conjunction with one or more releasable connection points of the first surgical model or first model support as described above to release the first surgical model or first model support from its releasable engagement with the base. Step 206 may optionally include using a cutout of the base to maintain a secure grip on the first surgical model or the first model support during removal.

At step 208, a second surgical model may optionally be inserted into the base of the device. In some embodiments, the second surgical model may be configured to simulate an anorectal malformation (ARM), including an imperforate anus, a rectal atresia, a rectal stenosis, a rectoperitoneal fistula, a cloacal fistula, a rectovestibular fistula, a rectobulbar urethral fistula, a rectoprostatic urethral fistula, a rectobladder neck fistula, or any other appropriate ARM or combination of ARM conditions. It will be appreciated that the first and second surgical models may be configured to simulate the same malformation or different malformations. The second surgical model may be disposed on or supported by a second model support as described above. Accordingly, step 208 may optionally include inserting a second model support into the base, or into a cavity of the base. Inserting a second surgical model or second model support may include releasably engaging the second surgical model or second model support, for example using the one or more releasable connectors of the base (or cavity of the base) in conjunction with one or more releasable connection points of the second surgical model or second model support as described above.

At step 210, a second simulated surgical procedure may be performed on the second surgical model. It will be appreciated that the first and second simulated surgical procedures may be the same procedures or different procedures. The second simulated surgical procedure may include performing one or more simulated procedure steps on one or more simulated tissues of the second surgical model. As described above, the one or more simulated tissues may include at least one of a simulated skin layer, a simulated muscle, a simulated fat layer, a simulated organ, or any combination thereof.

Some methods according to the present disclosure may further comprise positioning the surgical model at an angle relative to an underlying surface on which the base is disposed that simulates a position of a patient during a surgical procedure. For example, a surgical model may be positioned such that an angle between a sagittal axis of a simulated patient and the underlying surface may be formed as described above.

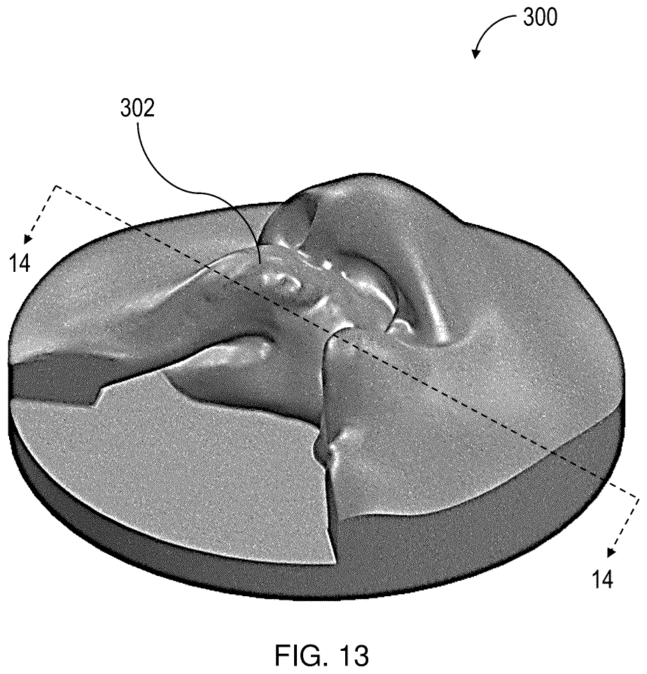

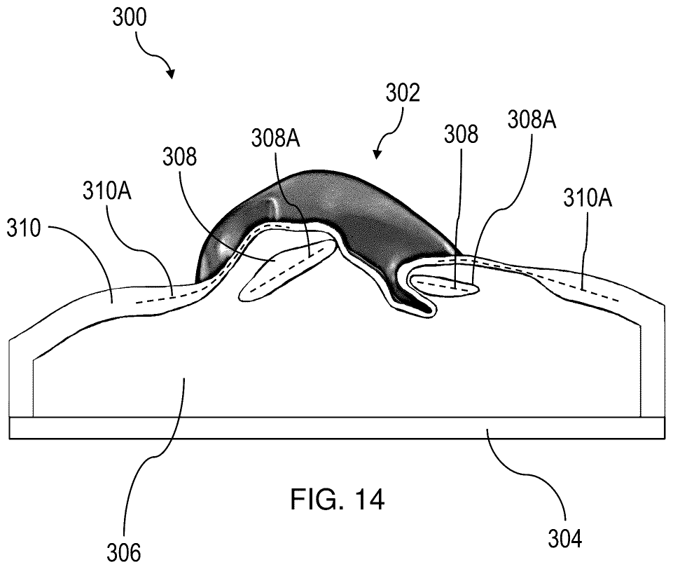

FIG. 13 depicts a cleft lip surgical model 300 including a cleft lip malformation 302. FIG. 14 illustrates a cross section taken through the surgical model of FIG. 13 taken along line 14-14. As shown in the cross section, the surgical model may include a model support 304 that the simulated tissues may be disposed on. A simulated fat layer 306 is disposed on the model support and one or more simulated muscles 308 may at least partially encapsulated in the bulk of the fat layer. In the depicted embodiment, the simulated muscles may include an appropriate muscle reinforcement 308A. As noted above, in some embodiments, the muscle reinforcement may be a porous non-woven material impregnated with a flexible material. For example, a felt material with a desired size and shape may be impregnated with silicone and encapsulated at least partially within the fat layer to provide the desired one or more simulated muscles. Similar to the prior embodiments, the cleft lip surgical model may also include a skin layer 310 disposed on at least a portion, and in some embodiments, all of, an exposed surface of the surgical model. To improve the ability of the skin layer to be sutured, dissected, and/or otherwise manipulated during a surgical procedure, the skin layer may include one or more reinforcements 310A disposed therein. For example, an elastic woven fabric, non-woven fabric, mesh, or web may be disposed within a portion of the skin layer that will be operated on during a simulated surgical procedure (e.g., within the portion of the model corresponding to the cleft lip).

The various surgical models described herein may be manufactured in any appropriate fashion using molding, casting, additive manufacturing, subtractive manufacturing (e.g., cutting and machining), combinations of the forgoing, and/or any other appropriate manufacturing technique. For example, in FIG. 15A, a mold 400 is depicted with a first projection 402 and second projection 404 extending into an interior volume of the mold. The first and second projections may have appropriate shapes to mimic the size and shape of a desired anatomical structure, such as a lumen within a body of a subject. For example, the lumens may correspond to an anal canal, a vaginal canal, and/or a urinary tract of a subject depending on the desired application. Any number of projections for forming one or more simulated lumens may be present as the disclosure is not so limited. Depending on the manufacturing process, the one or more projections may either be formed as a part of the mold and/or may be removable inserts to facilitate removal of the final surgical model from the mold.

As discussed previously, a tissue reinforcement may be desired for a particular lumen. Accordingly, a reinforcing material 406, which may correspond to any reinforcing material described herein, may be positioned on the first projection 402, or any other appropriate projection, prior to a formation process. As shown in the figure, the reinforcing material may extend at least partially, and in some embodiments entirely, around a perimeter of and along a length of the projection. A separate reinforcement material 410 may be disposed on a surface of the mold 400. In some embodiments and as shown, the mold may include an opening 408 that extends from a first interior surface of the mold to a second opposing exterior surface of the mold. The reinforcement material may be sized and shaped such that it extends around the opening. Additionally, an interior portion of the reinforcement material, which may be an elastic reinforcement material in some embodiments, may be deformed such that it extends through the opening with opposing portions of the reinforcement material located on opposing portions of the opening being spaced apart from one another.

After appropriately arranging the reinforcement materials 406 and 410 (or other reinforcement materials) in the mold 400, a first simulated tissue material 412 may be flowed into the internal volume of the mold and into contact with the reinforcement materials, see FIG. 15B. The reinforcement materials may become impregnated with and/or embedded within the first simulated tissue material. The material used to form simulated tissue 412 may be selected to function as a simulated organ, simulated skin, and/or other simulated tissue depending on the specific features being formed. In some embodiments, the mold 400 may be a negative mold with appropriate features to provide a desired size and shape of the molded simulated tissue. Additionally, while not illustrated, one or more second or opposing molds may be used in cooperation with the first mold to provide an overall desired size and shape of the simulated organ. For example, a cavity 412A has been formed in the molded material for inclusion of other simulated tissues. The cavity 412A may optionally be formed using the one or more second or opposing molds.

In FIG. 15C, second and third simulated tissues are being integrated with the surgical model. In the depicted embodiment, a porous reinforcement material 418A may be disposed and retained in a desired portion of the cavity on the first simulated tissue layer 412. Depending on the build order, this first tissue layer may be a simulated organ, simulated fat layer, and/or a simulated skin layer. An appropriate second mold, not depicted, may be engaged with the first mold 400 and the porous reinforcement material 418A. An appropriate flexible matrix material, such as a silicone or other material described herein, may then be impregnated into the porous material to form a second simulated tissue 418B (see FIG. 15D). In some embodiments, this second simulated tissue 418B may be a simulated muscle.

FIG. 15E illustrates an embodiment where another simulated muscle 414, or other simulated tissue, is attached to a retainer 416 associated with the mold 400. The simulated muscle may be held in a desired position and orientation within the cavity 412A. As described previously, the simulated muscle 414 may be formed in a separate formation process. For example, an injection molding process with appropriate reinforcement materials may used to form the simulated muscle 414. In either case, once appropriately positioned and oriented relative to the other portions of a surgical model being constructed, a second simulated tissue material 420 may be flowed into cavity 412A, at least partially encapsulating the first and second muscles 414 and 418A within the second simulated tissue. For example, the second simulated tissue may be a simulated fat layer that the one or more simulated muscles are disposed at least partially within (see FIG. 15F).

While not required, in some embodiments, as shown in FIGS. 15E and 15F, and as described elsewhere herein, multiple separate reinforcement materials may extend along at least a portion of a length of the second muscle 414 as indicated by the parallel lines. This may help to facilitate dissection of the second muscle along its length into two or more separate pieces without tearing. In such an arrangement, a plurality of reinforcing materials may extend along a length of at least a portion of the elongated simulated tissue. For example, the plurality of reinforcing materials extend in a direction that is substantially parallel to a length of the portion of the elongated simulated tissue. The plurality of reinforcing materials may include at least a first reinforcing material and a second reinforcing material where the first reinforcing material and the second reinforcing material are disposed on opposing sides of a longitudinal axis of the elongated simulated tissue such that the first and second reinforcing materials may be spaced apart from one another within a matrix of the simulated tissue. Thus, dissection, suturing of the dissected simulated tissue, and other types of manipulation of the simulated tissue may be improved relative to unreinforced simulated tissues.

As also illustrated in the figures, in instances where the simulated muscle 414 may have an opening 422 formed therethrough passing from a first surface of the simulated muscle to a second opposing surface of the simulated muscle. In some embodiments the separate reinforcement materials may extend along and pass on opposing sides of the opening. For example, a plurality of reinforcing materials may extend at least partially in a first direction that is aligned in a plane in which the opening is located. A first portion of the plurality of reinforcing materials may extend around a first side of the opening and a second portion of the plurality of reinforcing materials extend around a second side of the opening. Such an arrangement may be useful for example in the ARM surgical model described above wherein a portion of the simulated internal sphincter muscle may pass through an opening formed in the simulated external sphincter muscle.

It should be understood that the methods schematically illustrated in regard to FIGS. 15A-15F may be used to form any number of different simulated tissues with various openings, lumens, and/or other anatomical structures formed therein. Accordingly, while only two filling processes are illustrated, it should be understood that any number of molding and/or other formation processes may be used to form the desired simulated structures of a surgical model. Additionally, it should be understood that these various simulated structures may either be formed together in a single mold using sequential molding operations, separate formation processes using separate molds may be used to form different anatomical structures, and/or combinations of separate and combined formation processes may be used as the disclosure is not limited in this fashion.

Furthermore, it should be understood that in some embodiments, a model support as described above may be used as a mold, or a portion of a mold, for at least part of the molding operations described herein. For example, in embodiments in which a simulated muscle or other simulated tissue is retained or suspended within the surgical model (e.g., using tissue retainers as described above), it may be desirable to use the model support as a mold for at least a portion of the molding process in which an encapsulating layer is formed around the suspended tissue. For example, the uncured material for a simulated fat layer, or other simulated tissue, may be poured, or injection molded into a cavity within the model support with one or more other simulated tissues present therein to at least partially encapsulate the one or more other simulated tissues. While in the above embodiment, the model support is only used for a portion of the molding process, in other embodiments, the model support may serve as a mold for other portions or for the entirety of a molding process or other manufacturing process of a surgical model, as the disclosure is not limited in this fashion.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A surgical model comprising:
at least one simulated muscle including a reinforcing material disposed therein; and
a second simulated tissue at least partially encapsulating the at least one simulated muscle.

2. The surgical model of claim 1, wherein the reinforcing material comprises a porous non-woven material impregnated with a flexible matrix material.

3. The surgical model of claim 2, wherein the flexible matrix material is silicone.

4. The surgical model of claim 1, wherein the reinforcing material is polymer felt.

5. The surgical model of claim 1, wherein the second simulated tissue is a simulated fat layer.

6. The surgical model of claim 1, wherein the reinforcing material comprises at least one selected from a woven fabric, a non-woven fabric, a mesh, and a web.

7. The surgical model of claim 1, wherein the flexible reinforcing material is elastic.

8. The surgical model of claim 1, wherein the at least one flexible reinforcing material is substantially inextensible.

9. A surgical model comprising:
a simulated organ including at least one lumen; and
at least one flexible reinforcing material extending at least partially around and at least partially along a length of the at least one lumen, wherein the at least one flexible reinforcing material is embedded in a flexible matrix of the simulated organ.

10. The surgical model of claim 9, wherein the at least one flexible reinforcing material extends entirely around a perimeter of the lumen.

11. The surgical model of claim 9, wherein the at least one lumen includes at least one selected from a rectum and a vaginal canal.

12. The surgical model of claim 9, wherein the at least one flexible reinforcing material comprises at least one selected from a woven fabric, a non-woven fabric, a mesh, and a web.

13. The surgical model of claim 9, wherein the at least one flexible reinforcing material is elastic.

14. The surgical model of claim 9, wherein the at least one flexible reinforcing material is substantially inextensible.

15. The surgical model of claim 9, wherein the at least one flexible reinforcing material is a flexible tube.

16. The surgical model of claim 9, wherein the flexible matrix is silicone.

17. A surgical model comprising:
a simulated tissue;
an opening formed in the simulated tissue;
a plurality of reinforcing materials extending at least partially in a first direction, wherein a first portion of the plurality of reinforcing materials extend around a first side of the opening, and wherein a second portion of the plurality of reinforcing materials extend around a second side of the opening.

18. The surgical model of claim 17, wherein the plurality of reinforcing materials comprise at least one selected from a woven fabric, a non-woven fabric, a mesh, and a web.

19. The surgical model of claim 17, wherein the plurality of reinforcing materials include at least a first reinforcing material and a second reinforcing material, wherein the first reinforcing material and the second reinforcing material are disposed on opposing sides of a longitudinal axis of the elongated simulated tissue.

20. The surgical model of claim 17, wherein the simulated tissue is a first simulated tissue, and further comprising a second simulated tissue, wherein a portion of the second simulated tissue extends through the opening.

21. The surgical model of claim 20, wherein the first simulated tissue is a first simulated muscle, and the second simulated tissue is a second simulated muscle.

22. The surgical model of claim 20, further comprising a third simulated tissue at least partially encapsulating the first simulated tissue and the second simulated tissue.

23. The surgical model of claim 17, wherein the third simulated tissue is a simulated fat layer.

24. A surgical model comprising:
an elongated simulated tissue;
a plurality of reinforcing materials extending along a length of at least a portion of the elongated simulated tissue, wherein the plurality of reinforcing materials extend in a direction that is substantially parallel to a length of the portion of the elongated simulated tissue.

25. The surgical model of claim 23, wherein the plurality of reinforcing materials comprise at least one selected from a woven fabric, a non-woven fabric, a mesh, and a web.

26. The surgical model of claim 23, wherein the plurality of reinforcing materials include at least a first reinforcing material and a second reinforcing material, wherein the first reinforcing material and the second reinforcing material are disposed on opposing sides of a longitudinal axis of the elongated simulated tissue.

27. The surgical model of claim 23, further comprising a second simulated tissue at least partially encapsulating the elongated simulated tissue.

28. The surgical model of claim 23, wherein the second simulated tissue is a simulated fat layer.

29. The surgical model of claim 23, wherein the elongated simulated tissue is a simulated muscle
